(19) United States
(12) Patent Application Publication
(10) Pub. No.: US 2025/0086313 A1
(43) Pub. Date: Mar. 13, 2025

(54) SECURE PROCESSING SYSTEM AND METHOD

(71) Applicant: PQShield Ltd, Oxford (GB)

(72) Inventor: Markku-Juhani Olavi SAARINEN, Oxford (GB)

(21) Appl. No.: 18/958,880

(22) Filed: Nov. 25, 2024

Related U.S. Application Data
(63) Continuation of application No. PCT/GB2023/051377, filed on May 25, 2023.

(30) Foreign Application Priority Data
May 26, 2022 (GB) 2207808.3

(51) Int. Cl. G06F 21/62; G06F 21/60; G06F 21/64

(52) U.S. Cl. CPC G06F 21/6245; G06F 21/602; G06F 21/64

(57) ABSTRACT

There is discussed a secure processing environment configured to perform masked processing operations using a plurality of shares corresponding to sensitive data, the secure processing environment comprising memory storing a confidentiality key, a first module configured to perform at least one masked processing operation using a plurality of shares corresponding to sensitive data, a second module configured to export encapsulated key data and a third module configured to import the encapsulated key data. The second module generates cover data, the generation comprising encrypting a nonce value using a confidentiality key stored within the hardware security module, and performs a sequence of additive operations using the shares of the sensitive data and the cover data to generate a summation, generates a cyphertext indicating the summation, and exports a data package comprising the cyphertext and the nonce value. The third module imports a data package comprising a cyphertext and a nonce value, generates one or more uniformly random share, generates cover data, and performs a sequence of additive inverse operations to subtract the value of each uniformly random share and the cover data from the value of the cyphertext to generate a second plurality of shares corresponding to the sensitive data.

### CROSS-REFERENCE TO RELATED APPLICATIONS

This application is a continuation under 35 U.S.C. § 120 of International Application No. PCT/GB2023/051377, filed May 25, 2023, which claims priority to GB Application No. GB 2207808.3, filed May 26, 2022, under 35 U.S.C. § 119(a). Each of the above-referenced patent applications is incorporated by reference in its entirety.

### TECHNICAL FIELD

This disclosure relates to performing operations, such as cryptographic processing operations, in a secure processing environment. The disclosure has relevance to a post-quantum cryptographic system utilising masking as a countermeasure to side-channel attacks.

### BACKGROUND

Cryptographic processing operations involve the use of cryptographic keys. In a symmetric encryption system in which the same key is used to encrypt and decrypt a message, there is a need to protect that key from exposure to malicious parties. Similarly, for an asymmetric encryption system utilising a private key and a public key, there is a need to protect the private key from exposure to malicious parties. To protect the security of cryptographic keys, it is known to perform cryptographic processing operations in a secure processing environment including secure memory and a secure crypto-processor. An example of such a secure processing environment is a hardware security module.

An issue with a secure processing environment is that the amount of secure memory in the secure processing environment may be limited, preventing a large number of cryptographic keys being stored in the secure memory. To address this issue, it is known to encrypt a cryptographic key using a short symmetric key to generate a wrapped key which can be stored in less secure memory outside of the secure processing environment, with only the short symmetric key being permanently stored in the secure memory of the secure processing environment. Examples of such less secure memory include untrusted system main memory and external storage such as hard drives and cloud-based data storage.

To operate with wrapped keys, the secure processing environment requires: an export function to encrypt the cryptographic key to generate the wrapped key, and to export the wrapped key to the less secure memory; and a load function to import the wrapped key from the less secure memory to the secure processing element and to decrypt the wrapped key to recover the cryptographic key. In this way, the cryptographic key is never revealed unwrapped outside of the secure processing environment.

Processing performed in secure processing environments may be vulnerable to side-channel attacks in which an adversary learns side-channel information about the physical execution of an algorithm. The side-channel information may be derived from many sources such as running time, electromagnetic emissions, energy consumption and acoustic emissions. One countermeasure that has been proposed against side-channel attacks is masking, which relies upon techniques in the fields of secret sharing and multi-party computation (MPC). As an example, given a sensitive value x∈ [symbol] _{q}, masking x consists of representing x as a tuple (x₁, . . . , x_{d})∈ [symbol] _{q}^{d}, where d is the number of shares (also referred to as the sharing order) and in the context of masking d-1 is often called the masking order, such that (i) Σᵢ₌₁^{d}xᵢ=x mod q and (ii) any subset of t<d distinct xᵢ's looks uniformly random. This tuple may be represented by the notation [symbol] x [symbol] _{d} or [symbol] x [symbol] when d is clear in context. The rationale of masking is that an attacker with the ability of learning the value of t<d variables xᵢ will learn nothing about x.

As discussed above, cryptographic processing operations can be performed in the secure processing environment using the shares of the cryptographic key in place of the cryptographic key itself. This disclosure addresses techniques to export the shares of the cryptographic key in a secure manner.

### SUMMARY

Aspects of the present invention are set out in the appended independent claims. Certain variations of the invention are then set out in the appended dependent claims.

### BRIEF DESCRIPTION OF THE DRAWINGS

Examples of the invention will now be described, by way of example only, with reference to the accompanying drawings, in which:

FIG. 1 is a schematic illustration showing the main components of a cryptographic system according to an example;

FIG. 2 is a flow diagram schematically showing the operations performed to export in wrapped form a plurality of shares corresponding to a masked cryptographic key according to an example;

FIG. 3 is a flow diagram schematically showing the operations performed to load wrapped data representing a cryptographic key and generate a plurality of shares corresponding to the masked cryptographic key according to an example; and

FIG. 4 is a schematic illustration showing an example of masking being applied to secret data.

### DETAILED DESCRIPTION

### Introduction

Certain examples described herein relate to a cryptographic system implemented within a secure processing environment that forms part of a communicatively-coupled computing system and securely performs cryptographic operations required by that computing system. For example, the cryptographic system may be provided as a system-on-chip device for inclusion into a larger computing circuit board and/or integrated circuit. The cryptographic system may be implemented in silicon, i.e. as an integrated circuit design that is fabricated alone (e.g., as an Application Specific Integrated Circuit—ASIC) or together with a larger computing system circuit, and/or as an Field Programmable Gate Array (FPGA), e.g. in the form of a specific configuration of the FPGA that is programmed in a suitable hardware description language. In an example, the secure processing environment of the cryptographic module is formed by a hardware security module that provides a trusted processing environment and secure memory. The hardware security module may be tamper-proof, for example by using “potted” hardware, and/or tamper-evident such that attempts to physically access components within the hardware security module are prevented and/or detected.

The cryptographic system may be used as a “post-quantum” cryptographic module or co-processor, e.g. allowing one or more processors of the communicatively-coupled computing system to off-load complex “post-quantum” cryptographic operations for quick, secure computation. For example, the cryptographic system may be configured to implement key establishment and digital signature functions on behalf of the computing system. The cryptographic system has a security boundary such that other devices and integrated circuits of the computing system, including the computing system itself, do not have access to secret data that is manipulated within the cryptographic system. The cryptographic system may be configured to autonomously execute post-quantum cryptographic operations as part of a larger hardware system, such as a larger ASIC or FPGA design.

The term “post-quantum” is used herein to describe cryptographic operations and functions that provide protection against attack by a quantum computer. It is a well-known term within the field of cryptography. For example, many popular public-key algorithms are not post-quantum secure, they can be efficiently broken using a sufficiently strong quantum computer. These “quantum insecure” cryptographic algorithms include those based on the integer factorisation problem, the discrete logarithm problem or the elliptic-curve discrete logarithm problem; these may all be easily solved on a sufficiently powerful quantum computer using Shor's algorithm. Operations and functions that have been demonstrated to be post-quantum secure include those based on one or more of: lattice-based cryptography; multivariate cryptography; hash-based cryptography; code-based cryptography; and supersingular elliptic curve isogeny cryptography.

The cryptographic system of the examples is suitable for use in a wide variety of computing systems, from Internet servers to embedded devices. In one implementation, the cryptographic system may be provided as part of a cryptographic system-on-chip (SoC) that may allow for many low-cost embedded devices to implement “post-quantum” cryptography and provide “post-quantum” secure systems. For example, the functions implemented by the cryptographic math unit may allow code or lattice-based cryptographic operations to be rapidly performed, e.g. by off-loading many common low-level binary logic functions such as integer addition, subtraction and/or multiplication. The cryptographic system may be configured or pre-programmed with a set of available functions that may be updatable over time. The cryptographic system may rapidly compute certain functions by avoiding the need to load and interpret distinct instructions as required by a processor of the coupled computing system. The cryptographic system may be considered as a specialised computing device (i.e., a computer) that is designed for integration with larger general-purpose computing devices (e.g., for use as a computer within a computer).

### Example Cryptographic System

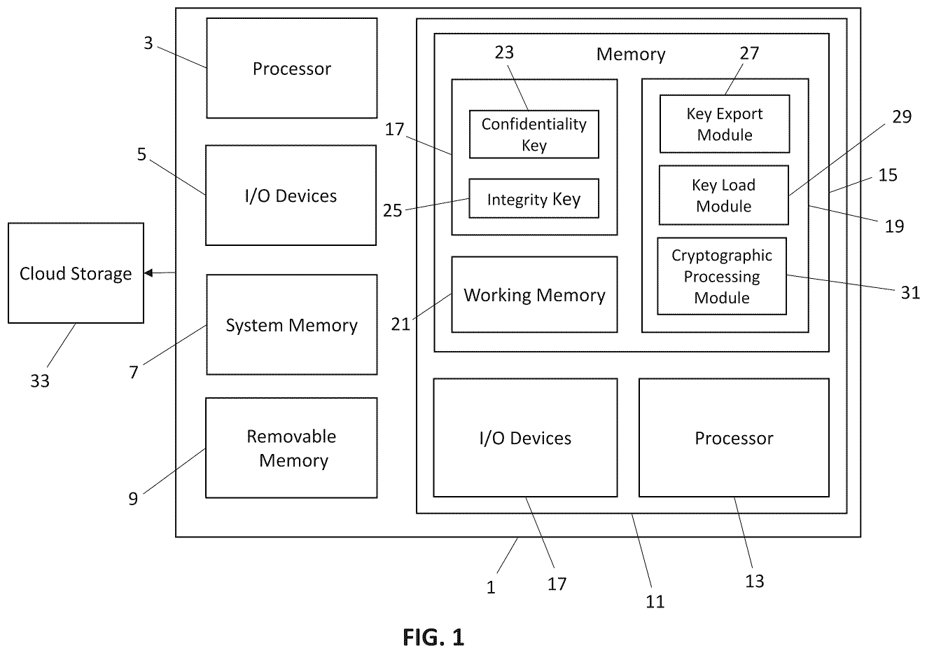

FIG. 1 shows a computing system 1 according to an example. The computer system 1 includes at least one processor 3, input/output devices 5, main system memory 7 and removable memory 9, such as a hard disk device and the like. In addition, the computing system 1 includes a cryptographic system 11 that provides a secure processing environment in which cryptographic processing operations are performed. In this example, the cryptographic system 11 is embodied within a hardware security module.

The cryptographic system 11 includes a processor 13, secure memory 15 and input/output devices 17 which enable communication with the remainder of the computer system 1. The secure memory 15 includes data memory 17, program memory 19 and working memory 21. The data memory 17 stores a confidentiality key K_{c} 21 and an integrity key Kᵢ 23. The program memory 19 stores a key export module 27, a key load module 29 and cryptographic processing module 31.

The processor 13 may comprise a Reduced Instruction Set Computer (RISC) processor such as a RISC-V central processing unit (CPU). The processor 13 may comprise a 32- or 64-bit microprocessor (e.g., such as an RV32-I/E-/M/C Pluto core). The processor 13 may comprise one or more processing cores.

In this example the computer system 1 also has access to cloud storage via network communications, for example via the Internet.

The cryptographic system 11 performs cryptographic processing operations using cryptographic keys. The cryptographic processing operations include: key establishment functions including one or more of encryption and decryption; digital signature functions including one or more of digital signature generation and digital signature verification; and stateful hash-based signatures. In this example, the cryptographic system 11 is optimised for lattice- and code-based cryptography (amongst other post-quantum approaches), as well as “big integer” arithmetic (e.g., arithmetic with large integer values as defined by n-bits where n may be for example 32 or 64).

In certain examples described herein, the security of the cryptographic system 11 is increased using masked computation, in which sensitive data processed by the computer system is represented within the cryptographic system by a plurality of secret shares such that all secret shares are required to derive information about the sensitive data. Masked computation provides protection against side-channel attacks, which seek to determine bit patterns of data being manipulated by the cryptographic system 11 based on, for example, leakage of secret information via electromagnetic emissions, fluctuations in power use, operation timing, or other unintended side channels, by not manipulating the sensitive data itself, but rather the shares of the sensitive data. The number of data shares may be configurable and set by a parameter of the cryptographic system 11 (e.g., there may be d data shares). Typical values of the number d of shares are two or three, but other numbers of shares are possible.

The cryptographic system 11 may perform cryptographic operations using many different cryptographic keys, and particularly for asymmetric cryptographic operations the number of bits in each cryptographic key may be large. The amount of non-volatile memory in the secure memory 15 may not be sufficient to store all the cryptographic keys, and this problem is compounded when the cryptographic keys are represented by multiple shares. Accordingly, the key export module 27 enables a cryptographic key to be stored outside of the cryptographic system 11 in encrypted form, while the key load module 29 enables the encrypted cryptographic key to be imported into the cryptographic system 11 and converted into a new set of secret shares for cryptographic processing operations within the cryptographic system 11. The operations of the key export module 27 and the key load module 29 will now be described in more detail.

### Key Export Module

The key export module 27 includes a set of processor-implementable instructions which, when implemented by the processor 13, process a plurality of shares corresponding to a cryptographic key to generate a cyphertext that can safely be exported external to the cryptographic system 11. In this example, the cyphertext is exported as part of a data package including an integrity tag that enables the integrity of data stored in the data package to be verified.

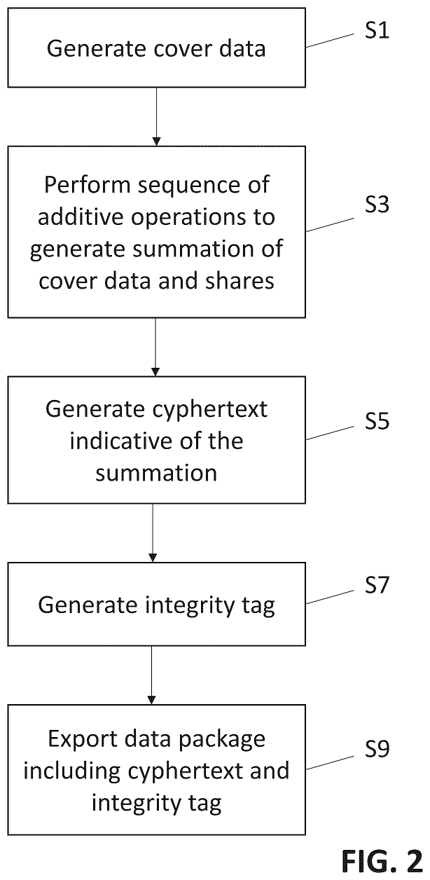

FIG. 2 is a flow chart showing the main operations performed by the key export module 27 in this example. As shown, in this example the key export module 27 generates, at S1, cover data t using a function E(K_{c},N) that takes in the confidentiality key K_{c} and a unique nonce value N as inputs and outputs either a vector of uniform bits of arbitrary length or a vector of uniform numbers in the range [0,q−1], with arbitrary integer q. Rejection sampling can be used to obtain uniform numbers in the range [0, q−1] from uniform bit strings. In this process, we take consecutive segments of b=ceil(log2 (q)) bits. The bit string can be interpreted as integer x, uniform in range 0≤x<2b, with q<2b. Looking at each x, if condition x<q is satisfied, we accept x as uniform in the range [0, q−1], while if x≥q we reject all the bits in x and take a new segment of bits until we find one satisfying x<q. This process is repeated until the entire vector is finished. Another method that will produce distributions close to, but not exactly uniform is to select larger b-bit strings 2b>q and reduce x from the range [0,2b−1] via simple remaindering operation: x mod q.

The confidentiality key K_{c} can be a symmetric key of 128, 256, or more bits, masked shares of such a key, a hashed or protected password or passphrase, an access token, a secure key storage handle, or may be produced by a key derivation function, or any similar mechanism. The confidentiality key K_{c} may be hard-coded into the cryptographic system 11 and hence not actually passed to the function E(K_{c},N).

The output vector is cryptographically secure in that it is not feasible to determine anything about the confidentiality key K_{c} from the output vector or, conversely, to observe any statistical anomaly or additional feature in the vector without the confidentiality key K_{c}.

The function E(K_{c},N) may be instantiated with a secure block cipher such as the Advanced Encryption Standard AES in counter mode, a stream cipher such as ChaCha20, or a hash function or eXtensible Output Function (XOF) such as SHAKE. Typically, the cipher function E(K_{c},N) is itself protected against side-channel attacks via masking or other countermeasures.

Returning to FIG. 2, the key export module 27 performs, at S3, a sequence of additive operations to generate a summation of the cover data t and the plurality of secret shares S[1 . . . d]. In particular, the output vector from E(K_{c}, N) is loaded into a temporary vector t. The secret shares S[1 . . . d] are then added to the temporary vector t in a sequence of additive operations, with each element reduced (mod q) in the case of arithmetic masking, and then the resultant vector t is returned as summation Sc. These processing operations can be represented as follows:

for i = 1 .. d do:
t = t + S[i] (mod q)
end do
return Sc = t

In the case of Boolean masking, the exclusive-or (XOR) operation replaces the modular addition of vectors.

The summation Sc satisfies Sc=S+E(K_{c},N). The confidentiality of S is fully protected if E (K_{c},N) is secure and its output distribution is uniform. So, this result is analogous to a “one-time pad”, with the “one-time pad” from the E(K_{c},N) being added modulo q.

In order to provide side-channel security, in this example the addition of cover string E(K_{c}, N) to S[1] is done before the addition of other shares S[2]. In contrast, if S[1 . . . d] were added together first, before adding E(Kc, N), the numerical result would be the same, but the entire secret S would be temporarily stored by the cryptographic system 11 and therefore potentially open to being compromised via leakage. While in this example the addition of cover string E(K_{c}, N) to S[1] is done before the addition of other shares, it will be appreciated that as long as one of the operands for the last additive operation of the sequence of additive operations is one of the shares S[1 . . . d] of the cryptographic key, the entire secret will not be being temporarily stored by the cryptographic system 11.

The key export module 27 then generates, at S5, a cyphertext indicative of the summation Sc. In this example, the cyphertext is the summation Sc, but it will be appreciated that determinative arithmetic operations may be performed on the summation Sc to generate the cyphertext.

In this example, the key export module 27 then generates, at S7, an integrity tag Si. In particular, in this example the generation of the integrity tag Si comprises encrypting the cyphertext and metadata A associated with generation of the cyphertext using the integrity key Kᵢ 23 stored in the secure memory 15. In this example, the metadata A includes the nonce value N, modulus q, the length of the vector l (number of elements mod q), number of shares d, an algorithm identifier id, and any additional public or private key parameters pk and sk. More particularly, in this example the integrity tag Si equals MAC (Kᵢ,Sc,A), where MAC is a keyed message authentication code that can be instantiated with the HMAC, KMAC, or similar standard algorithms.

Finally, the key export module 27 exports, at S9, a data package including the cyphertext Sc, the nonce value N and the integrity tag Si from the secure processing environment of the cryptographic system 11 to a less secure storage environment, which may for example be in the main system memory 7, the removable memory 9 or cloud storage 31.

### Key Load Module

The key load module 29 includes a set of processor-implementable instructions which, when implemented by the processor 13, retrieves from memory external to the cryptographic system a data package including a cyphertext indicative of a cryptographic key S stored in protected form, and generates a plurality of d secret shares S[1 . . . d] corresponding to the cryptographic key. In this example, as discussed above, the data package also includes the nonce value N and the integrity tag Si.

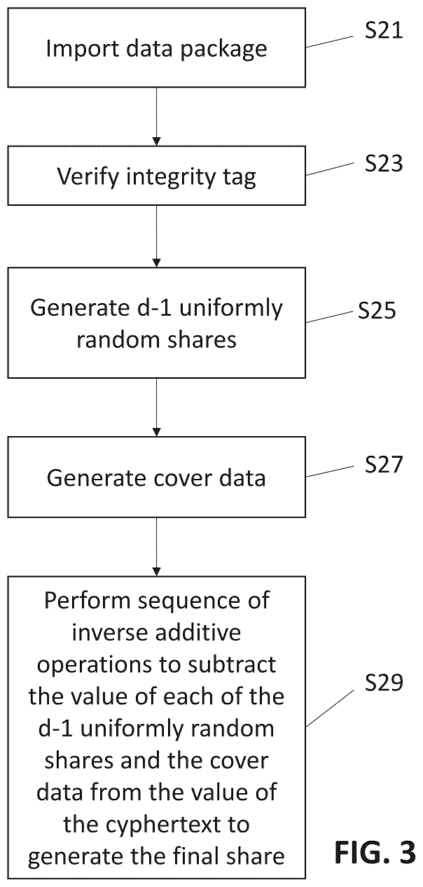

FIG. 3 is a flow chart showing the main operations performed by the key load module 29 in this example. As shown, in this example the key load module 27 imports, at S21, the data package and verifies, at S23, data within the data package using the integrity key Si. In particular, the key load module 27 decodes the data package to recover the cyphertext Sc, the nonce N and the integrity tag Si, constructs the metadata A and then calculates a test tag Ti that equals MAC(Kᵢ,Sc,A). If the test tag Ti matches the integrity tag Si, the data of the data package is verified and the key load module proceeds with generation of the plurality of d secret shares. If, however, the test tag Ti does not match the integrity tag Si then this indicates that the data of the data package has been tampered with and the key load module 29 ends processing operations.

Having verified the integrity tag, the key load module 29 generates, at S25, d−1 uniformly random secret shares S[1 . . . d−1]. In order to generate the uniformly random secret shares S[1 . . . d−1], the output of a secure random bit generator can be subjected to the rejection sampling process described above for E(K_{c}, N).

The key load module 29 then generates, at S27, cover data using the function E(K_{c}, N) described above, using the confidentiality key K_{c} stored in the secure memory 15 and the nonce value N recovered from the imported data package. The key load module 29 then performs, at S29, a sequence of inverse additive operations to subtract the value of each of the d−1 uniformly random shares and the cover data from the value of the cyphertext to generate the final share S[d]. These processing operations can be represented as follows:

```
t = Sc
for i = 1, 2, .., d−1 do
  u = uniform random vector in [0,q−1]
  S[i] = u
  t = t − u (mod q)
end do
S[d] = t − E(Kc, N) (mod q)
Return vector S[1..d]
```

It will be appreciated that for Boolean masking the inverse additive operations “−” can be replaced by XOR operations. Again, to avoid the cryptographic key S being temporarily stored by the cryptographic system, the order of the inverse additive operations is important. While the subtraction of the cover vector is performed last in the routine outlined above, it will be appreciated that any order that does not involve subtracting the cover data from the cyphertext will have the desired improvement in data security. In other words, the first additive inverse operation should comprise the value of one of the one or more uniformly random shares and the value of the cyphertext as operands.

There is no need for the random secret shares [S1 . . . d] to match the secret shares used to generate the data package. On the contrary, refreshing the secret shares improves the security against side channel attacks by making any data leaked though such side channel attacks more difficult to analyse. Indeed, if the number d of secret shares may be different when the secret shares S[1 . . . d] are refreshed.

### Cryptographic Processing Module

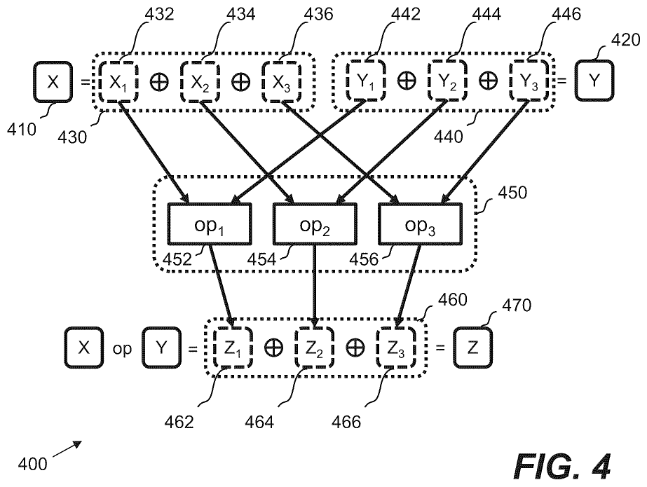

In masked cryptographic computation, arithmetic may be transformed into corresponding masked operations. For example, an unmasked (plain) arithmetic operation between variables X and Y, resulting in Z: Z=X op Y, may be transformed into a series of arithmetic operations from shares {Xᵢ} and {Yᵢ} to provide shares {Zᵢ}. This example is shown in FIG. 4.

FIG. 4 shows an operation 400 performed on two input data variables 410 and 420 (shown as X and Y). Each of the two input variables 410 and 420 are split into respective sets of data shares 430 and 440. In this example, there are three data shares, such that the first input variable 410 is split into data shares 432, 434 and 436 and the second input variable 420 is split into data shares 442, 444, and 446. Each of the data shares may comprise a sequence of bits of the same length as a sequence of bits representing the input variables. In the example of FIG. 4, the input variables are split into data shares using Boolean masking; however, different forms of masking may be available as a configurable or selectable control parameter. For example, there may be an option to generate data shares using either Boolean masking or arithmetic masking (amongst others). The cryptographic system may further be configured to convert between different forms of masking for certain operations.

The data shares can be used to perform an operation 450. The operation 450 is performed as a set of independent operations 452, 454 and 456 that each receive corresponding data shares from the two sets of data shares 430 and 440, e.g. operation 452 is performed with data shares 432 and 442 as input, operation 454 is performed with data shares 434 and 444 as input, and operation 456 is performed with data shares 436 and 446 as input. Each independent operation 452 to 456 is a repeat of the same arithmetic unit operation. Each of the masked arithmetic operations 452 to 456 (including conversions to masked form) is designed so that all intermediate variables are statistically independent of the (secret) sum of shares. The operations 452 to 456 are performed on the data shares of the secret but the data shares are not “collapsed” to reform the secret. Hence, the original secret is not “given away” to side-channel attacks.

In FIG. 4, after the operation 450 is performed on respective pairs of data shares, the result from each of the individual operations 452, 454 and 456 are provided as respective outputs 462, 464, and 466. The output set of data shares 460 may be recomposed to provide a result of the operation 450 as applied to the input variables 410 and 420 (i.e., Z=oper(X, Y)). In the example of FIG. 4, the recomposition may be performed by XOR summing the individual data shares, i.e. Z=Z₁⊕Z₂⊕Z₃. This may be performed as a last stage, e.g. when providing data as output via the set of bus interfaces 120 or following the completion of the operation 450, may be performed externally (e.g., by the external computing system), or even performed only when the data shares are encrypted as described below.

In certain implementations (and/or defined configurations), secret information may be maintained as data shares for an entire key lifecycle. For example, secret keys may be generated as shares, stored and loaded into memory as shares (e.g., both internal and external memory, the latter via the cryptographic registers 122), and used as shares (e.g., in cryptographic operations). At the end of the life of the key, the shares may then be zero-ed. In certain cases, only secret information is operated on as data shares. In these cases, if a set of data shares representing secret information are encrypted (e.g., using encryption and/or encapsulation algorithms implemented by the cryptographic system), they may be collapsed together following encryption, as the data is no longer “secret” (i.e., it is protected by the encryption). For example, a stream cipher may produce ciphertext C from plaintext P and keystream Z=cipher(key) via C=P XOR Z where decryption is performed as P=C XOR Z. In cases where the cipher is implemented in a masked fashion, the keystream shares Z₁, Z₂, Z₃ may be generated from masked keys—key₁, key₂, key₃. In this case different ciphertext portions may be encrypted using respective keystream shares C₁=P₁ XOR Z₁, C₂=P₂ XOR Z₂, and C₃=P₃ XOR Z₃. Following encryption, it is now possible to collapse the masks without giving away secret information, i.e. C=C₁ XOR C₂ XOR C₃. C can then be exported safely in an encrypted form that reveals no information about P.

Although the example of FIG. 4 shows a case of Boolean masking, in other examples, arithmetic masking may alternatively be used. In one case, arithmetic masking in the form of additive masking may be used to generate the data shares. Additive masking is analogous to XOR masking but uses integer or modular addition. In one case, the shares are computed as: X=(Σ_{d}Xᵢ) mod(q) where q may be an algorithm-dependent small prime or q=2ⁿ modulus. As an example, additive masking may be implemented by wrap-around addition modulus 2¹⁶. The fixed constant q may vary for different cryptographic algorithms. For many cryptographic algorithms, q is less than 16 or 32 bits in size or exactly a power of two. As examples, the KYBER algorithm uses a q value of 3329 and the SABER algorithm uses a value of 2¹³. Values of q for different cryptographic algorithms may be hardcoded into the implementation of the cryptographic math unit 130. As an example, the number X=1238 may be represented using shares X₁=1111, X₂=2222 and X₃=1234 with a q value of 3329, since X₁+X₂+X₃=4567 mod q=1238 (using modular wrap around addition).

In certain examples, the cryptographic system 110 may be arranged to perform operations that convert between two different masking formats. For example, linear operations such as XOR or addition may only be independently applied to data shares if the data shares are in a corresponding masking format. In one case, Boolean masking may be converted to and from arithmetic masking. In a case where Boolean masking is converted to arithmetic masking, this may be performed by determining a second set of data shares {Yᵢ} that have a sum that is equal to the XOR sum of a first set of data shares {Xᵢ}, e.g. S=⊕Xᵢ=ΣYᵢ. In a case where arithmetic masking is converted to Boolean masking, the reverse operation may be performed, e.g. a second set of data shares {Yᵢ} may be determined that have a sum that is equal to the arithmetic sum of a first set of data shares {Xᵢ}, e.g. S=ΣXᵢ=⊕Yᵢ. In certain cases, the control unit 150 may be programmed to use the arithmetic unit 136 and the matrix memory 132 to perform conversion operations in the hardware of the cryptographic system 110 that are similar to the conversion operations described in the paper “An Instruction Set Extension to Support Software-Based Masking” by Gao et al, Cryptology ePrint Archive, Report 2020/77, which is incorporated herein by reference. For example, the aforementioned paper defines BOOL2ARITH and ARITH2BOOL conversion functions that in turn utilise underlying Boolean add (BOOLADD) and Boolean substitution (BOOLSUB) operations. These Boolean add and Boolean substitution operations in turn comprise relatively complex sequences of bit manipulations involving a “mask random” input. The present cryptographic system 110 provides a large advantage over the software implementations of the paper (e.g., that are typically performed by a central processing unit of the external computing system), as the cryptographic math unit 130 is designed (and optimised) for accelerated execution of long sequences of Boolean operations (e.g., as demonstrated by the pipeline of FIG. 3). Hence, the cryptographic system 110 allows much faster operations.

Certain arithmetic primitives that are applied as operations by the arithmetic unit 136 may be accomplished with the help of conversion functions within a masked mode of operation (or the conversion functions may be implemented with the direct operations). For example, for Boolean masked addition and subtraction, a set of output data shares {Zᵢ} may be computed from input shares {Xᵢ} and {Yᵢ} such that the XOR sums satisfy X+Y=Z or X−Y=Z (mod q). Other masked functions may follow the same pattern. Bitwise logic in a masked mode may be performed by applying, say, AND, OR, and XOR operations to arithmetic-masked or Boolean-masked data shares. Likewise, shifts, rotations and bit manipulations may be applied to arithmetic-masked or Boolean-masked data shares. Comparisons may be performed by analysing equivalence or ordered (e.g., using less-than or greater-than) of masked variables. The results of comparisons may also be masked (e.g., a true or false value may be a masked bit). Field arithmetic and special functions for post-quantum cryptography may also be applied to masked variables.

Certain post-quantum cryptographic operations operate on ring polynomials. For example, lattice-based cryptography utilises ring polynomial and matrix multiplications. Many of these multiplications are between secret polynomials and public polynomials. In these cases, the secret polynomials may be masked, and the public polynomials need not be masked. In a case of multiplication of a secret polynomial X with a public polynomial C, the secret polynomial may be split into d data shares for a masked mode of operation, e.g. such that CX=CX₁+CX₂+CX₃ (mod q). In this case, multiplying by a constant (the public polynomial C) only causes an O(d) increase in complexity. This means that lattice-based post-quantum cryptography is particularly suited to a masked mode of operation. As a comparison, a multiplication of two masked representations, e.g. (X₁+X₂+X₃)*(Y₁+Y₂+Y₃), causes at least an O(d²) (i.e., quadratic) overhead in relation to the number of shares. Similarly, for many Number-Theoretic Transforms (NTT) that are used to implement ring and module algebraic objects used for known lattice cryptographic schemes, only one input of an NTT multiplication needs to be masked. This limits the overhead of applying a masking mode. Lattice cryptography additionally uses mixed bit-oriented operations such as right-shifts, “rounding,” and masked comparison. These tasks can be accomplished with more efficient partial masking conversion tailored for each operation.

Masking is applied in examples herein as a side-channel attack countermeasure. The cryptographic system 11 provides for hardware-accelerated cryptographic operations with integral hardware masking support. The masking may be configured to meet the requirements of the “non-invasive attack countermeasures” described in the FIPS 140-3 and ISO 19790 security standards, which are both incorporated by reference herein, (e.g., those defined in Section 7.8 of ISO/IEC 19790:2012(E)). Testing of the effectiveness of countermeasures such as masking as described herein may be performed using laboratory procedures such as those described in ISO/IEC 17825:2016(E) “Testing methods for the mitigation of non-invasive attack classes against cryptographic modules”, which is incorporated by reference herein, and more generally called Test Vector Leakage Assessment (TVLA).

### Modifications and Further Examples

In the Key Export example described above, the temporary vector t and the stored secret Sc are not themselves masked. In an alternative example, a masked temporary vector is split into e shares t[1], t[2], . . . t[e] which sum up to the temporary vector t, and a masked stored secret [[Sc]] is stored. An example implementation a Key Export function and a Key Load function for such an arrangement will now be described. In this example implementation, for simplicity it is assumed that the cyphertext [[Sc]] also has e shares, although this is not essential.

To generate the masked temporary vector t, this example implementation utilises a masked encryption function E(Kc,N)[i] which generates e shares t[1], t[2] . . . t[e] such that t[1]+t[2]+ . . . +t[e]=the cover data, where e is less than or equal to d. The masked encryption function E(Kc,N) may for example be a masked implementation of the hash function SHAKE or a block cipher such as AES. Each of the e shares is then loaded into a respective share t[i] of a temporary vector.

After generating the masked temporary vector t, the key export function performs a sequence of masked additive operations in which each of the d shares S[1], S[2], . . . . S[d] of the secret S is added to one of the e shares t[1], t[2], . . . t[e] of the temporary vector t. This can be performed, for example, in a cyclical manner such that S[1] is added to t[1], S[2] is added to t[2] and so forth until S[e] is added to t[e], after which S[e+1] is added to t[1] (such that in comparison with the original share t[1] output by the masked encryption function E(Kc,N), t[1]=t[1]+S[1]+S[e+1]) and so forth. The resultant masked vector having e shares is then returned as the cyphertext [[Sc]]. These processing operations can be represented as follows:

```
for i = 1 .. e do:
  t[i] = E(Kc,N)[i]
end do
j = 1
for i = 1, 2 .. d do:
  t[j] = t[j] + S[i] (mod q)
  j = j + 1
  if j > e then set j = 1
end do
return [[Sc]] = [[t]]
```

In this way, each share of the cyphertext corresponds to the modular addition of a share of the temporary vector t and one or more shares of the secret S, whereby the shares of the ciphertext correspond to a summation of shares of the sensitive data and the shares of the cover data. In the case of Boolean masking, the exclusive-or (XOR) operation replaces the modular addition of vectors.

It will be appreciated that the ordering of the indices i and j could be randomised.

In the corresponding key load function to recover the secret shares [[S]], each of e shares of the ciphertext is loaded into a respective share of a temporary vector t. A set of d random uniform vectors S[1], S[2], . . . S[d] is then generated, and each random uniform vector is subtracted from one of the shares of the temporary vector by performing an inverse modulo q addition to generate a modified temporary vector having e shares. Again, this can be performed in a cyclical manner. The masked encryption function E(Kc,N)[i] is then utilised to generate the e shares of cover data, and then each share of the cover data is subtracted from a respective one of the e shares of the modified temporary vector. Finally, the resultant e shares of the modified temporary vector are added to respective ones of the set of random uniform vectors S[1], S[2], . . . S[d], and the resultant set of d vectors form d shares of the sensitive data S (e.g a cryptographic key). These processing operations can be implemented as follows:

```
for I = 1, 2, .. e do:
  t[i] = Sc[i]
end do
j = 1
for i = 1, 2, .. d do
  u = uniform random vector in [0, q−1]
  S[i] = u
  t[j] = t[j] − u (mod q)
  j = j + 1
  if j > e then set j = 1
end do
for i = 1, 2, .. e do
  t[i] = t[i] − E(Kc, N)[i] (mod q)
  S[i] = S[i] + t′[i]
end do
Return vector [[S]]
```

It will be appreciated that for Boolean masking the inverse additive operations “−” can be replaced by XOR operations.

By using the uniform random vectors u, the d shares of the sensitive data S are effectively refreshed each time the key load function is executed, which provides additional protection against side channel attacks.

### Brief Summary of Example Features

Certain examples described herein provide a device (e.g., a cryptographic system or co-processor) that is able to perform post-quantum cryptography with masked arithmetic, i.e. data provided as masked data shares for side-channel protection. A masked mode of operation may utilise one or more of Boolean and arithmetic masking, and the device may provide for conversion between (at least these) different forms of masking. The described examples provide a novel cryptographic system structure or configuration that performs masking operations in a flexible and efficient manner to allow for both accelerated post-quantum cryptographic co-processing and high-security against side-channel attacks.

Certain examples described herein provide a device (e.g., a cryptographic system or co-processor) that is able to assist and/or accelerate cryptographic computations as well as perform certain full post-quantum cryptographic operations autonomously. For example, the device allows for public-key key establishment and encryption such as generation of a public-private key pair, encapsulation and/or encryption, and decapsulation and/or decryption. The device further allows digital signature functions such as generation of a public-private integrity key pair, signature generation and signature verification, as well as stateful hash-based signatures, such as assistance and/or acceleration of key generation, signature generation and/or signature verification functions. Such a device may be provided as a system-on-chip (e.g., integrated within a silicon design and/or provided as a separate FPGA/ASIC chip that may be attached).

Certain examples described herein provide a cryptographic system that is able to provide secure cryptographic computation. For example, one or more of the following post-quantum public-key encryption algorithms may be implemented: Classic McEliece, (CRYSTALS-) KYBER, NTRU, SABER, BIKE, FrodoKEM, HQC, NTRU Prime, SIKE, and Supersingular Isogeny Diffie-Hellman (SIDH); as well as one or more of the following post-quantum digital signature algorithms: (CRYSTALS-) DILITHIUM, FALCON, Rainbow, GeMSS, and Picnic. Further details of these algorithms may be found in available NIST publications for the “Post-Quantum Cryptography Project”, and publications for the CRYSTALS project—“Cryptographic Suite for Algebraic Lattices—Kyber and Dilithium”, which are incorporated by reference herein.

Certain examples described herein have a control unit that controls cryptographic operations without handling sensitive data (so-called “no-touch” operation). For example, the control unit may not have access to sensitive data in the cryptographic math unit during operation.

Certain examples further provide a method by which a control unit or processor may provide security tracking of secret data throughout cryptographic operations; hence, a control unit or processor may track the flow of sensitive information within the cryptographic system but without having access to that data.

It will be appreciated that the presence of the integrity tag is optional. If an integrity tag is present, then rather than having an integrity key separate from the confidentiality key, the confidentiality key could be used also as the integrity key so that the confidentiality key and the integrity key are the same.

The functions provided in the secure processing environment may be implemented in software, hardware or a combination of software of hardware. Accordingly, the key export module 27, a key load module 29 and cryptographic processing module 31 could be implemented as processor-implementable instructions which, when executed by a processor, perform their respective functions or a hardware circuit, for example an FPGA or an ASIC, which performs their respective functions, or a combination of processor-implementable instructions and hardware.

The above examples are to be understood as illustrative. Further examples are envisaged. Although certain components of each example have been separately described, it is to be understood that functionality described with reference to one example may be suitably implemented in another example, and that certain components may be omitted depending on the implementation. It is to be understood that any feature described in relation to any one example may be used alone, or in combination with other features described, and may also be used in combination with one or more features of any other of the examples, or any combination of any other of the examples. For example, features described with respect to the system components may also be adapted to be performed as part of the described methods. Furthermore, equivalents and modifications not described above may also be employed without departing from the scope of the invention, which is defined in the accompanying claims.

1. A secure processing environment configured to perform masked processing operations using a plurality of shares corresponding to sensitive data, the secure processing environment comprising:
memory storing a confidentiality key;
a first module configured to perform at least one masked processing operation using a plurality of shares corresponding to sensitive data; and
a second module configured to:
generate cover data, the generation comprising encrypting a nonce value using a confidentiality key stored within the secure processing environment;
following generation of the cover data, performing a sequence of additive operations using the shares of the sensitive data and the cover data to generate a summation;
generate a cyphertext indicating the summation; and
export a data package comprising the cyphertext and the nonce value.

2. A secure processing environment according to claim 1, wherein the cover data is unmasked and one of the operands for the last additive operation of the sequence of additive operations is one of the shares of the sensitive data.

3. A secure processing environment according to claim 2, wherein one of the operands for the first additive operation of the sequence of additive operations is the cover data.

4. A secure processing environment according to claim 1, wherein the sequence of additive operations comprises modular additive operations.

5. A secure processing environment according to claim 4, wherein the modular additive operations comprise at least one of arithmetic modulo q addition, where q is a prime number or a power of two, and Boolean exclusive-OR bitwise addition.

6. A secure processing environment according to claim 1, wherein the second module is configured to generate masked cover data having a plurality of shares, and for each of the plurality of share of the sensitive data performing an additive operation with a share of the cover data to generate a plurality of shares corresponding to a summation of shares of the sensitive data and the shares of the cover data.

7. A secure processing environment according to claim 1, further comprising generating an integrity tag and including the integrity tag in the data package, wherein the generation of the integrity tag comprises encrypting the cyphertext and metadata associated with the cyphertext using an integrity key stored in the memory.

8. A secure processing environment according to claim 7, wherein the metadata comprises the nonce value.

9. A secure processing environment according to claim 7, wherein the integrity key is the confidentiality key.

10. A secure processing environment according to claim 7, wherein the integrity tag comprises a method authentication code for the data package.

11. A secure processing environment according to claim 1, wherein the memory further comprises a third module configured to:
import the data package comprising the cyphertext and the nonce value;
generate one or more uniformly random shares;
generate cover data, the generation of the cover data comprising encrypting the nonce value using the confidentiality key;
perform a sequence of additive operations to subtract the value of each uniformly random
share and the cover data from the value of the cyphertext to generate a plurality of shares corresponding to the sensitive data.

12. A secure processing environment configured to perform masked processing operations using a first plurality of shares corresponding to sensitive data, the secure processing environment comprising:
memory storing a confidentiality key; and
a module configured to:
import a data package comprising a cyphertext and a nonce value;
generate one or more uniformly random shares; and
generate cover data, the generation of the cover data comprising encrypting the nonce value using the confidentiality key; and
perform a sequence of additive inverse operations to subtract the value of each uniformly random share and the cover data from the value of the cyphertext to generate a second plurality of shares corresponding to the sensitive data.

13. A secure processing environment according to claim 12, wherein the cover data is unmasked and the first additive operation uses the value of one of the uniformly random shares and the value of the cyphertext as operands.

14. A secure processing environment according to claim 12, wherein an operand for the last of the sequence of additive operations comprises the value of the cover data.

15. A secure processing environment according to claim 12, wherein the sequence of inverse additive operations comprises modular additive operations.

16. A secure processing environment according to claim 15, wherein the modular additive operations comprise at least one of arithmetic modulo q addition, where q is a prime number or a power of two, and Boolean exclusive-OR bitwise addition.

17. A secure processing environment according to claim 12, wherein the data package further comprises an integrity tag, and wherein the module is configured to verify the integrity tag before generating the plurality of shares from the cyphertext by:
generating a verification tag by encrypting the cyphertext and metadata associated with the cyphertext using an integrity key stored in the memory;
checking the verification tag matches the integrity tag; and
in the event that the verification tag matches the integrity tag, generating the plurality of shares.

18. A secure processing environment according to claim 17, wherein the metadata comprises the nonce value.

19. A method of storing a plurality of shares that correspond to sensitive data and are utilised within a secure processing environment to perform masked processing operations, the method comprising:
generating cover data, the generation comprising encrypting a nonce value using a confidentiality key stored within the secure processing environment;
following generation of the cover data, performing a sequence of additive operations to generate a summation of the shares of the sensitive data and the cover data;
generating a cyphertext indicating the summation; and
exporting a data package comprising the cyphertext and the nonce value for storage outside of the secure processing environment.

20. A method of generating a plurality of shares within a secure processing environment, the plurality of shares corresponding to sensitive data and utilised to perform masked processing operations within the secure processing environment, the method comprising:
importing a data package comprising a cyphertext and a nonce value, the cyphertext being based on the sensitive data and the nonce value;
generating one or more uniformly random shares;
generating cover data, the generation of the cover data comprising encrypting the nonce value using the confidentiality key; and
performing a sequence of additive inverse operations to subtract the value of each uniformly random share and the cover data from the value of the cyphertext to generate the plurality of shares corresponding to the sensitive data.
